(19) United States
(12) Patent Application Publication
(10) Pub. No.: US 2008/0297605 A1
(43) Pub. Date: Dec. 4, 2008

(54) APPARATUS FOR IMAGE PROCESSING

(75) Inventors: Boo Dong Kwak, Suwon (KR); Won Tae Choi, Hwasung (KR); Byung Hoon Kim, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., Suwon (KR)

(21) Appl. No.: 12/128,387

(22) Filed: May 28, 2008

(30) Foreign Application Priority Data
Jun. 4, 2007 (KR) 10-2007-54706

(51) Int. Cl. H04N 3/28

(52) U.S. Cl. 348/206; 348/E05.055

(57) ABSTRACT

An apparatus for image processing includes an image sensor including a pixel array of a plurality of pixels, the pixel array having equal vertical and horizontal lengths; a buffer storing image signals scanned at the image sensor; and a controller reading out the image signals stored in the buffer according to a gradient of the image sensor with respect to a reference direction set to a predetermined value on an X-Y plane.

### CROSS-REFERENCE TO RELATED APPLICATIONS

This application claims the priority of Korean Patent Application No. 2007-54706 filed on Jun. 4, 2007, in the Korean Intellectual Property Office, the disclosure of which is incorporated herein by reference.

### BACKGROUND OF THE INVENTION

1. Field of the Invention

The present invention relates to an apparatus for image processing, and more particularly, to an apparatus for image processing, which employs an image sensor including a pixel array with equal vertical and horizontal lengths, so that an image can be displayed in the same direction as an image direction detected by an image sensor, regardless of a gradient of the image sensor.

2. Description of the Related Art

The evolution of mobile telephone terminals and mobile telephone services is leading to development of mobile terminals provided with built-in or external cameras. Furthermore, for video communications, a technology to detect an image using a camera of a mobile terminal and send the image to a mobile terminal of another party is being developed.

FIGS. 1A and 1B illustrate pixel arrays used in an image sensor 11 and a display device 12 used in a related art image processing apparatus.

Referring to FIG. 1A, an aspect ratio of a pixel array of the image sensor 11 is 4:3, and an aspect ratio of a pixel array of the display device 12 is also 4:3. In this case, image loss or distortion does not occur even though image signals scanned by the image sensor 11 are read out in the display device 12 in a scanning order.

Referring to FIG. 1B, the aspect ratio of the pixel array of the image sensor 11 is 3:4, and the aspect ratio of the pixel array of the display device 12 is 4:3. This may occur when an image sensor with a pixel array having an aspect ratio of 4:3 is mounted to a mobile telephone and the mobile telephone or the image sensor 11 is inclined to a gradient of 90°.

A start pixel (s) from which scanning is started and a scanning direction are fixed in the image sensor 11. For this reason, as illustrated in FIG. 1B, if the display device 12 reads out image signals scanned by the image sensor 11 in the scanning order, an image is displayed on the display device 12, inclined by the gradient of the image sensor 11. To display an image without being affected by the gradient of the image sensor 11, a receiver may rotate the image. However, this may reduce an original image in size or undesirably cut out both edges of the image.

### SUMMARY OF THE INVENTION

An aspect of the present invention provides an apparatus for image processing, which can display an image in the same direction as an image direction detected by an image sensor, regardless of a gradient of the image sensor.

According to an aspect of the present invention, there is provided an apparatus for image processing including: an image sensor including a pixel array of a plurality of pixels, the pixel array having equal vertical and horizontal lengths; a buffer storing image signals scanned at the image sensor; and a controller reading out the image signals stored in the buffer according to a gradient of the image sensor with respect to a reference direction set to a predetermined value on an X-Y plane.

The image sensor may be rotatable on the X-Y plane. The image sensor may perform scanning with a start pixel and a scanning direction fixed, wherein the start pixel is a pixel from which the scanning begins in the pixel array.

The buffer may store the image signals in a scanning order of the image sensor.

The controller may include: a gradient determination unit determining a gradient of the image sensor; and an operation unit reading out the image signals stored in the buffer according to the gradient.

The operation unit may rotate the image signals stored in the buffer by the gradient of the image sensor and read out the image signals stored in the buffer according to an aspect ratio of a display device that displays an image.

The operation unit may include an offset control part selecting a portion of the image signals stored in the buffer such that an image being displayed on the display device corresponds with the aspect ratio of the display device.

The aspect ratio of the display device may be 4:3.

The operation unit may change a read-out direction in which the image signals stored are the buffer is read out, according to the gradient of the image sensor.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A and 1B illustrate pixel arrays of an image sensor and a display device used in a related art apparatus for image processing;

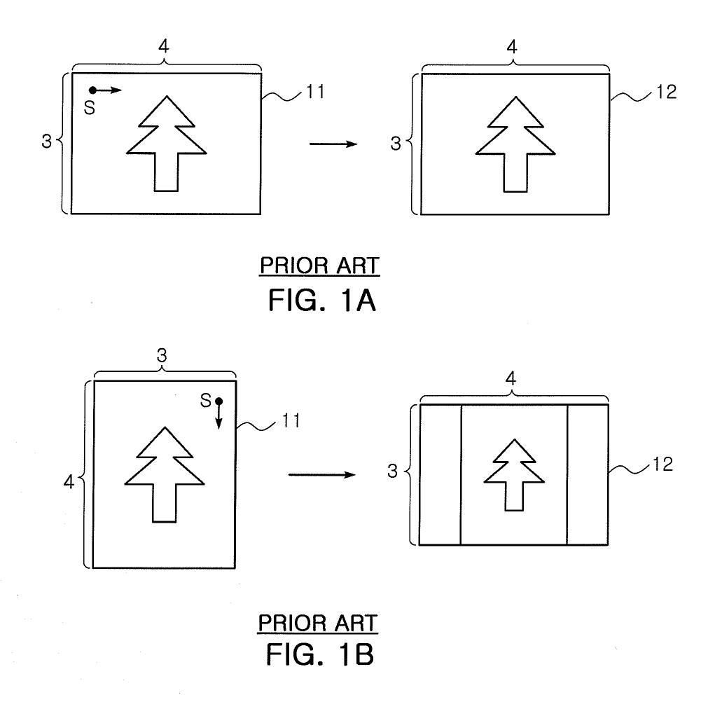

FIG. 2 is a block diagram of an apparatus for image processing according to an exemplary embodiment of the present invention;

FIG. 3 is a block diagram of a controller of an apparatus for image processing according to an embodiment of the present invention;

FIGS. 4A through 4C are views for explaining an image processing process of an apparatus for image processing, according to an embodiment of the present invention; and

FIGS. 5A through 5C are views for explaining an image processing process of an apparatus for image processing, according to another embodiment of the present invention.

### DETAILED DESCRIPTION OF THE PREFERRED EMBODIMENT

Exemplary embodiments of the present invention will now be described in detail with reference to the accompanying drawings.

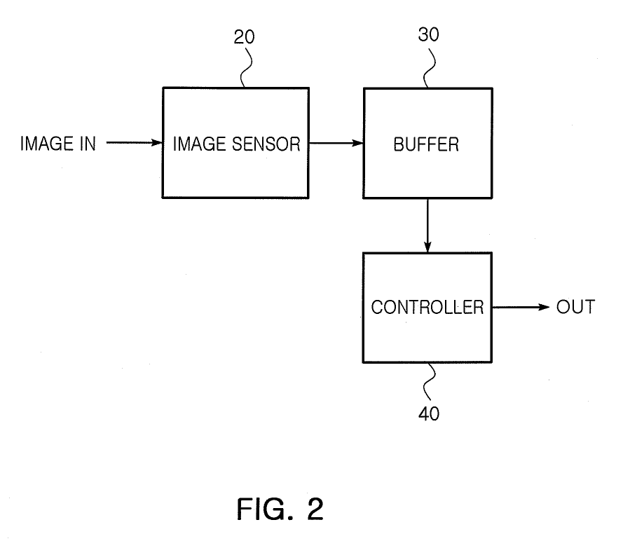

FIG. 2 is a block diagram of an apparatus for image processing according to an exemplary embodiment of the present invention.

Referring to FIG. 2, the apparatus for image processing according to the exemplary embodiment of the present invention includes an image sensor 20, a buffer 30 and a controller 40.

In the image sensor 20, a plurality of pixels may be arrayed to detect an image. Hereinafter, the arrayed pixels may also be referred to as a pixel array. The pixel array of the image sensor 20 may have equal vertical and horizontal lengths.

The image sensor 20 may scan the plurality of pixels arrayed to detect an image and convert the image into image signals. According to the current embodiment, a pixel (s) (hereinafter, referred to as a start pixel) from which scanning begins among the plurality of pixels, and a scanning direction may be fixed.

The image sensor 20 sequentially scans data of a line to which the start pixel (s) belongs, and then scans data of the next line when the scanning on the previous line is completed. In such a scanning manner, the image sensor 20 scans the pixel array. However, the present invention is not limited to the start pixel and the scanning direction illustrated in the drawing, and the start pixel and the scanning direction may be varied.

The scanned image signals may be converted into a digital signal by an analog-digital (A/D) converter (not shown).

The image sensor 20 may be rotatably formed.

The rotatable image sensor 20 may be mounted to a mobile communication terminal. In this case, as a body of the mobile communication terminal is rotated on the X-Y plane, the image sensor 20 may also rotate with respect to a reference direction of a predetermined value set at the time of mounting the image sensor 20. According to the current embodiment, only the image sensor 20 may be rotatable on the X-Y plane regardless of a direction of the mobile communication terminal body.

According to the current embodiment, the image sensor 20 that is mounted to the mobile communication terminal and rotatable on the X-Y plane may be used with the gradient of 0°, 90°, −90° or 180°.

The gradient of the image sensor 20 indicates a gradient of the image sensor 20 on an X-Y plane with respect to a predetermined direction set at the time of mounting the image sensor 20. To determine the gradient of the image sensor 20, the image sensor 20 may be connected with a gradient detection sensor (not shown). The gradient detection sensor may be mounted in the image sensor 20.

As for the rotatable image sensor 20, only the image sensor 20 rotates while the body of the mobile communication terminal stays still. Thus, it is required to display an image in the same direction as an image direction detected by the image sensor 20 even if a user of the mobile communication terminal changes the gradient of the image sensor 20. Hereinafter, the image direction detected by the image sensor 20 may also be referred to as an original direction.

According to the current embodiment, the pixel array of the image sensor 20 may have equal vertical and horizontal lengths. If the pixel array of the rotatable image sensor 20 has different vertical and horizontal lengths, an image is recognized according to a rotating direction of the image sensor, which may undesirably cause the image to be reduced in size or partially un-displayed at the time of image display on a display device.

Since the pixel array of the image sensor 20 has the equal vertical and horizontal lengths according to the current embodiment, displaying an image in the original direction is facilitated even if the image sensor 20 rotates. The image can be displayed with its original direction maintained by cutting off just a portion of the entire image detected by the image sensor 20.

The vertical and horizontal lengths of the pixel array of the image sensor 20 may be at a certain ratio with a longer one of vertical and horizontal lengths of a display device that displays the image. That is, if an aspect ratio of the display device is 4:3, the vertical and horizontal lengths of the pixel array of the image sensor 20 may correspond to 4, which represents a longer length of the display device. Accordingly, the image detected by the image sensor 20 can be displayed, occupying a screen of the display device to a maximum extent.

The buffer 30 stores an image scanned from the image sensor 20.

The buffer 30 may store the image in the scanning order of the image sensor 20.

That is, if the gradient of the image sensor 20 is 0°, an image maybe stored in the buffer 30 in its original direction. However, if the gradient of the image sensor 20 is 90° or −90°, the image may be stored in the buffer 30, rotated by −90° or 90° from the original direction of the image.

The buffer 30 temporally stores an image signal detected by the image sensor 20, so that read-out of the image signal can be controlled according to the gradient of the image sensor 20.

In other words, the buffer 30 allows additional processing to be performed on an image stored therein according the gradient of the image sensor 20 when an aspect ratio of the pixel array of the image sensor 20 is different from an aspect ratio of the display device that displays an image.

The controller 40 serves to read out an image signal stored in the buffer 30.

According to the current embodiment, the controller 40 may determine the gradient of the image sensor 20 and control the read-out of the image signal stored in the buffer 30 according to the determined gradient of the image sensor 20.

The gradient of the image sensor 20 indicates a gradient of the image sensor 20 with respect to a reference direction set to a predetermined value on the X-Y plane. To determine the gradient of the image sensor 20, the image sensor 20 may be connected with a gradient detection sensor.

When the gradient of the image sensor 20 is not 0°, the controller 40 compensates for the rotation of an image signal in due consideration of the gradient. Thus, the controller 40 can read out an image having a constant direction regardless of the gradient of the image sensor 20.

For example, if the gradient of the image sensor 20 is 90°, the controller 40 may rotate an image signal stored in the buffer 30 by 90° to read out the rotated image signal.

Alternatively, an image gradient in the display device can be compensated by designating a different read-out direction in which an image stored in the buffer 30 is read out, according to the gradient of the image sensor 20. That is, the image gradient in the display device can be compensated by controlling the read-out direction according to the gradient of the image sensor 20.

If the gradient of the image sensor 20 is 180°, an image detected by the image sensor 20 is turned upside down when stored in the buffer 30. In this case, an image in the same direction as when the gradient of the image sensor 20 is 0° can be obtained by reading out the image stored in the buffer 30 in a direction opposite to a read-out direction in the case where the gradient of the image sensor 20 is 0°.

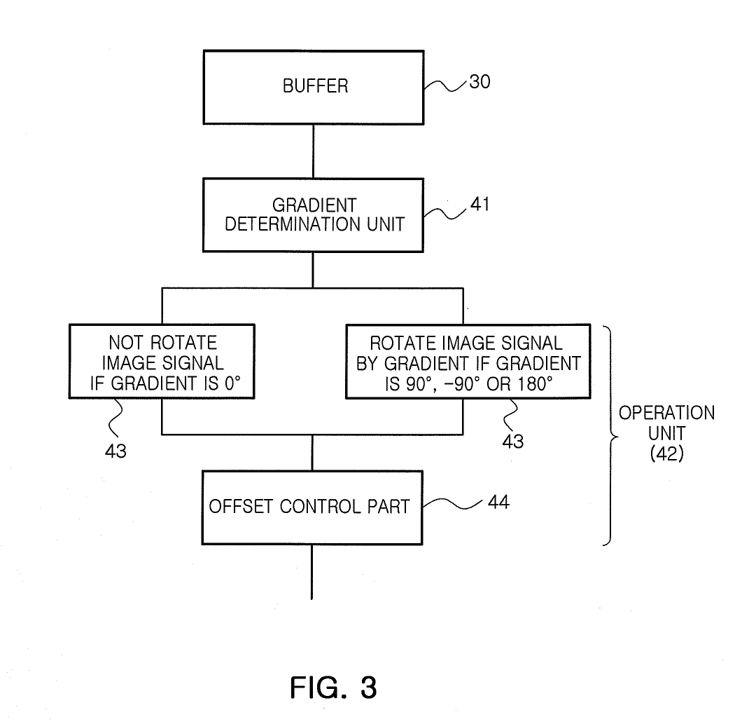

FIG. 3 is a block diagram of a controller 40 of an apparatus for image processing according to an embodiment of the present invention.

Referring to FIG. 3, the controller 40 according to the current embodiment includes a gradient determination unit 41 and an operation unit 42. The operation unit 42 may include an offset control part 44.

The gradient determination unit 41 may determine a gradient of the image sensor 20.

The gradient of the image sensor 20 is an angle of the image sensor 20 rotated on the X-Y plane with respect to a predetermined reference direction set at the time of mounting the image sensor 20 to a mobile communication terminal. The angular range of the gradient of the image sensor 20 may be 0° to 360°.

When the rotatable image sensor 20 is mounted to the mobile communication terminal, the image sensor 20 may be used with the gradient of 90°, −90° or 180°.

The operation unit 42 may control the read-out according to the gradient of the image sensor 20.

According to the current embodiment, when the gradient determination unit 41 determines the gradient of the image sensor 20, the operation unit 42 may rotate an image signal stored in the buffer 30 by the gradient (see 43 of FIG. 3). The gradient determination unit 41 may be connected with a gradient detection sensor (not shown) that detects a gradient of the image sensor 20. The gradient detection sensor may be formed inside or outside the image sensor 20.

For example, if the gradient of the image sensor 20 is 0°, image signals scanned by the image sensor 20 are stored in the buffer 30 in the scanning order of the image sensor 20. In this case, an image is stored in the buffer 30 in the same direction as an image direction detected by the image sensor 20 and thus the operation unit 42 can read out the signals stored in the buffer 30 as they are. Thus, a direction of an image being displayed can be the same as the image direction detected by the image sensor 20.

If the gradient of the image sensor 20 is 90°or −90°, image signals scanned by the image sensor 20 are stored in the buffer 30 in the scanning order of the image sensor 20. In this case, an image is stored in the buffer 30, rotated by −90° or 90° from the image direction detected by the image sensor 20. Thus, the operation unit 42 may rotate the image signals stored in the buffer 30 by 90° or −90° and read out the rotated image signals in order to display an image in the same direction as the image direction detected by the image sensor 20.

If the gradient of the image sensor 20 is 180°, an image rotated by −180° from the image direction detected by the image sensor 20 may be stored in the buffer 30. In this case, the operation unit 42 must rotate the image stored in the buffer 30 by the gradient of the image sensor 20, i.e., by 180°, and read out the rotated image in order to display an image in the same direction as the image direction detected by the image sensor 20.

As described above, the operation unit 42 may rotate an image stored in the buffer 30 by the gradient of the image sensor 20 and read out the rotated image. Accordingly, an image can be displayed in the same direction as the image direction of the image detected by the image sensor 20 regardless of the gradient of the image sensor 20.

The operation unit 42 may further include the offset control part 44.

The offset control part 44 may select a portion of the image signals to match with the aspect ratio of a display device that is to display the image signals.

According to the current embodiment, an image stored in the buffer 30 has an aspect ratio of 1 since the pixel array of the image sensor 20 has the equal vertical and horizontal lengths. Thus, it is required to control image signals stored in the buffer 30 to correspond with the aspect ratio of the display device. For example, if the aspect ratio of the display device is 4:3, the offset control part 44 may select and read out only a portion of an image that is stored in the buffer 30 with an aspect ratio of 4:4.

The portion of the stored image signals may be variously selected. For example, image signals representing a lower region or an upper region of an image may be selected. Alternatively, image signal representing a central region of the image may be selected. Such offset control may be implemented variously.

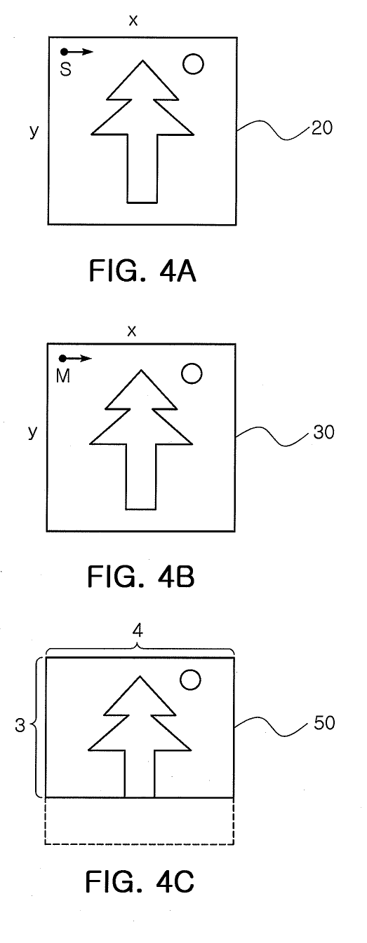

FIGS. 4A through 4C illustrate images processed in an apparatus for image processing, according to an embodiment of the present invention.

FIG. 4A illustrates an image of the image sensor 20. Since the image sensor 20 has not rotated, the x-direction is a horizontal axis and the y-direction is a vertical axis. That is, a reference direction set at the time of mounting the image sensor 20 to a body of, e.g., a mobile communication terminal is maintained, and thus the gradient of the image sensor 20 is 0°.

The pixel array of the image sensor 20 has equal horizontal and vertical lengths. That is, the x-axis and the y-axis are equal in length.

To convert the image into a digital signal, scanning is performed with a start pixel (s) and a scanning direction fixed in the pixel array of the image sensor 20. After data of a line to which the start pixel (s) belongs are all scanned, data of the next line are scanned. For example, when the pixel array of the image sensor 20 is 640×640, 640 lines are sequentially scanned, and 640 frames are scanned for each line.

FIG. 4B illustrates an image represented by image signals scanned by the image sensor and stored in the buffer 30. The signals are stored in the buffer 30 in the scanning order of the image sensor 20.

That is, in the buffer 30, the image signals scanned by the image sensor 20 are stored line by line and frame by frame, using one pixel data (m) as a start point.

Thus, an image stored in the buffer 30 may be aligned in the same direction as the image direction of the image sensor 20.

FIG. 4C illustrates an image displayed on a display device 50 by reading out the image signals stored in the buffer 30.

The image signals stored in the buffer 30 are read out by the operation unit 42 to display an image on the display device 50. The operation unit 42 may determine a gradient of the image sensor 20 and control the read-out according to the gradient of the image sensor 20.

According to the current embodiment, since the gradient of the image sensor 20 is 0°, the operation unit 42 may directly read out the image signals stored in the buffer 30 without rotating the image signals.

A pixel array of the display device 50 has an aspect ratio of 4:3. Accordingly, a portion of the image signals stored in the buffer 30 must be selected and read out in order to display an image stored in the buffer 30 on the display device 50. The selective read-out may be performed by the offset control part 40.

According to the current embodiment, image signals corresponding to an upper region of the image are selected among the image signals stored in the buffer 30 with the aspect ratio of 1, so that an image corresponding with the aspect ratio of the display device 50 is displayed.

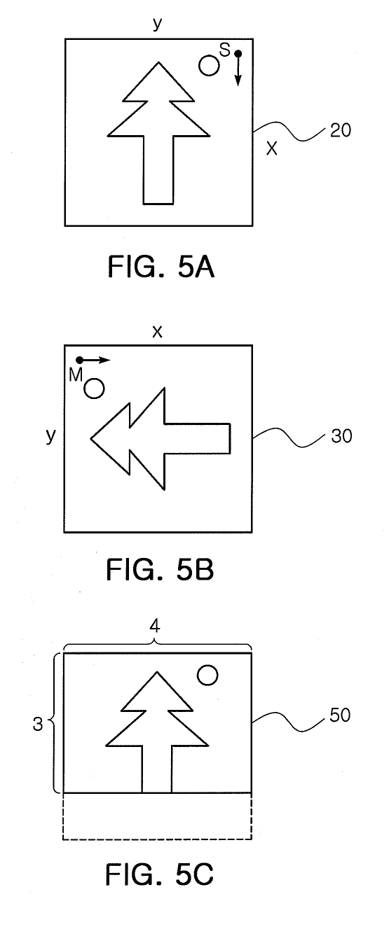

FIGS. 5A through 5C respectively illustrate images processed in an apparatus for image processing, according to another embodiment of the present invention.

FIG. 5A illustrate an image detected by the image sensor 20. In FIG. 5A, the image sensor 20 has rotated by 90° with respect to a reference direction, and thus the x-direction is a vertical axis and the y-direction is a horizontal axis. That is, the image sensor 20 has a gradient of 90° with respect to a direction of the image sensor 20 set when the image sensor 20 is mounted to a body of, e.g., a mobile communication terminal.

The pixel array of the image sensor 20 has equal vertical and horizontal lengths. That is, the x-axis and the y-axis of the pixel array are equal in length.

To convert the image into a digital signal, scanning is performed with a start pixel (s) and a scanning direction fixed. After data of a line to which the start pixel (s) belongs are all scanned, data of the next line may be scanned.

FIG. 5B illustrates an image represented by image signals scanned by the image sensor 20 and stored in the buffer 30. The signals are stored in the buffer 30 in the scanning order of the image sensor 20.

That is, in the buffer 30, the image signals scanned by the image sensor 20 are stored line by line and frame by frame, using one pixel data (m) as a start point.

Thus, the image stored in the buffer 30 may be aligned in a direction rotated by −90° from an image direction detected by the image sensor 20.

FIG. 5C illustrates an image displayed on the display device by reading out the image signals stored in the buffer 30.

To display an image on the display device 50, the image signals stored in the buffer 30 may be read out by the operation unit 42. The operation unit 42 may determine a gradient of the image sensor 20 and control the read-out according to the gradient.

According to the current embodiment, since the gradient of the image sensor 20 is 90°, the operation unit 42 may rotate the image signals stored in the buffer 30 by 90° and then read out the rotated image.

The pixel array of the display device 50 has an aspect ratio of 4:3.

Thus, to display the image signals stored in the buffer 30 on the display device 50, a portion of the image signals stored in the buffer 30 must be selected and read out. The selective read-out may be performed by the offset control part 44.

According to the current embodiment, image signals corresponding to an upper region of an image are selected among the image signals that are stored in the buffer 30 with the aspect ratio of 1, so that a displayed image corresponds with the aspect ratio of the pixel array of the display device 50.

In the case where the gradient of the image sensor 20 is not 0°, if image signals stored in the buffer 30 are directly read out without compensating the gradient, an image rotated by the gradient of the image sensor 20 may be output. According to the current embodiment, to display an image in the same direction as an image direction detected by the image sensor 20 by compensating the gradient of the image sensor 20, image signals of the buffer 30 are rotated by the gradient of the image sensor 20 before the read-out of the image signals.

That is, if the gradient of the image sensor 20 is −90° or 180°, the operation unit 42 rotates an image stored in the buffer 30 by −90° or 180° and then reads out the rotated image. Accordingly, an image can be displayed in the same direction as the image direction detected by the image sensor 20.

In the apparatus for image processing according to the present invention, an image of a fixed direction can be obtained regardless of a gradient of the image sensor. Also, undesired image cut-off in the display device can be prevented from occurring due to the gradient of the image sensor. Thus, a direction of a camera can be variously set during video communication.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for image processing, the apparatus comprising:
an image sensor comprising a pixel array of a plurality of pixels, the pixel array having equal vertical and horizontal lengths;
a buffer storing image signals scanned at the image sensor; and
a controller reading out the image signals stored in the buffer according to a gradient of the image sensor with respect to a reference direction set to a predetermined value on an X-Y plane.

2. The apparatus of claim 1, wherein the image sensor is rotatable on the X-Y plane.

3. The apparatus of claim 1, wherein the image sensor performs scanning with a start pixel and a scanning direction fixed, the start pixel being a pixel from which the scanning begins in the pixel array.

4. The apparatus of claim 1, wherein the buffer stores the image signals in a scanning order of the image sensor.

5. The apparatus of claim 1, wherein the controller comprises:
a gradient determination unit determining a gradient of the image sensor; and
an operation unit reading out the image signals stored in the buffer according to the gradient.

6. The apparatus of claim 5, wherein the operation unit rotates the image signals stored in the buffer by the gradient of the image sensor, and reads out the image signals stored in the buffer according to an aspect ratio of a display device that displays an image.

7. The apparatus of claim 6, wherein the operation unit comprises an offset control part selecting a portion of the image signals stored in the buffer such that an image being displayed on the display device corresponds with the aspect ratio of the display device.

8. The apparatus of claim 7, wherein the aspect ratio of the display device is 4:3.

9. The apparatus of claim 5, wherein the operation unit changes a read-out direction in which the image signals stored in the buffer are read out, according to the gradient of the image sensor.
